(19) United States
(12) Patent Application Publication
(10) Pub. No.: US 2019/0086715 A1
(43) Pub. Date: Mar. 21, 2019

(54) DISPLAY SUBSTRATE, DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Bing BAI, Beijing (CN); Xiaofeng LIU, Beijing (CN); Hui ZHENG, Beijing (CN); Dongxi LI, Beijing (CN); Minghui ZHANG, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/512,584

(22) PCT Filed: Apr. 20, 2016
(86) PCT No.: PCT/CN2016/079741

§ 371 Date: Mar. 20, 2017

(30) Foreign Application Priority Data
Feb. 16, 2016 (CN) 201610087208.0

(51) Int. Cl. G02F 1/1335

(52) U.S. Cl. CPC G02F 1/133512; G02F 2001/133567; G02F 1/133514; G02F 1/133553

(57) ABSTRACT

The present disclosure provides a display substrate, a display panel and a display device. The display substrate forms a cell with an opposite substrate. A black matrix is arranged on the display substrate or the opposite substrate. The display substrate includes a base substrate and a photoluminescent device arranged on the base substrate. The photoluminescent device is arranged at a position corresponding to the black matrix and located at a side of the black matrix facing a backlight module. A projection of the photoluminescent device onto the base substrate at least partially overlaps a projection of the black matrix onto the base substrate. The photoluminescent device is configured to emit light under an excitation of a light beam.

### CROSS-REFERENCE TO RELATED APPLICATION

The present application claims a priority of the Chinese patent application No. 201610087208.0 filed on Feb. 16, 2016, which is incorporated herein by reference in its entirety.

### TECHNICAL FIELD

The present disclosure relates to the field of display technology, in particular to a display substrate, a display panel and a display device.

### BACKGROUND

A liquid crystal display (LCD) has been widely used as a mainstream display device due to its advantages such as light-weight, low power consumption and low radiation. It is a trend for the LCD to be light and thin, wide color gamut, high brightness, low power consumption, narrow bezel, and the like. Among factors that prevent the power consumption of the LCD from being reduced, a low efficiency of utilizing light of a backlight module of the LCD is a major one.

### SUMMARY

An object of the present disclosure is to provide a display substrate, a display panel and a display device, so as to improve backlight efficiency of the display panel, which is adversely affected by the light adsorption by a black matrix in the related art.

In one aspect, the present disclosure provides in some embodiments a display substrate which forms a cell with an opposite substrate. The display substrate includes a base substrate and a photoluminescent device arranged on the base substrate. The photoluminescent device is arranged at a position corresponding to a black matrix and located at a side of the black matrix facing a backlight module. A projection of the photoluminescent device onto the base substrate at least partially overlaps a projection of the black matrix onto the base substrate. The photoluminescent device is configured to emit light under an excitation of a light beam.

In a possible embodiment of the present disclosure, the projection of the photoluminescent device onto the base substrate completely overlaps, or is located within, the projection of the black matrix onto the base substrate.

In a possible embodiment of the present disclosure, the photoluminescent device includes a photoluminescent layer and a light-shielding layer arranged between the photoluminescent layer and the black matrix.

In a possible embodiment of the present disclosure, the light-shielding layer includes a light reflection surface at a side of the light-shielding layer that is further away from the black matrix than the other side of the light-shielding layer.

In a possible embodiment of the present disclosure, the photoluminescent layer is made of a matrix and a photoluminescent material doped within the matrix.

In a possible embodiment of the present disclosure, the photoluminescent device is arranged between the base substrate and a thin film transistor (TFT) on the display substrate, or arranged at a surface at a side of the base substrate that is further away from the TFT than the other side of the base substrate

In a possible embodiment of the present disclosure, a polarizer is arranged at a side of the base substrate facing the backlight module, and the photoluminescent device is arranged at a side of the polarizer facing the backlight module.

In a possible embodiment of the present disclosure, the black matrix is arranged on the display substrate or the opposite substrate.

In a possible embodiment of the present disclosure, the projection of the black matrix onto the base substrate is located within the projection of the photoluminescent device onto the base substrate.

In a possible embodiment of the present disclosure, the photoluminescent device is a nonconductive light-emitting layer.

In a possible embodiment of the present disclosure, the light generated by the photoluminescent device is transmitted in a direction away from the black matrix.

In another aspect, the present disclosure provides in some embodiments a display panel including the above-mentioned display substrate.

In yet another aspect, the present disclosure provides in some embodiments a display device including the above-mentioned display panel and a backlight module. Light generated by the photoluminescent device reaches the backlight module, is reflected by the backlight module and enters the display panel.

In still yet another aspect, the present disclosure provides in some embodiments a display substrate which forms a cell with an opposite substrate. The display substrate includes a base substrate and a light reflection film arranged on the base substrate. The light reflection film is arranged at a position corresponding to a black matrix and located at a side of the black matrix facing a backlight module. A projection of the light reflection film onto the base substrate at least partially overlaps a projection of the black matrix onto the base substrate. A light reflection surface of the light reflection film is at a side of the light reflection film that is further away from the black matrix than the other side of the light reflection film.

In a possible embodiment of the present disclosure, the projection of the light reflection film onto the base substrate completely overlaps, or is located within, the projection of the black matrix onto the base substrate.

In a possible embodiment of the present disclosure, the light reflection film is arranged between the base substrate and a TFT on the display substrate, or at a side of the base substrate that is further away from the TFT than the other side of the base substrate.

In a possible embodiment of the present disclosure, the black matrix is arranged on the display substrate or the opposite substrate.

In a possible embodiment of the present disclosure, the projection of the black matrix onto the base substrate is located within the projection of the light reflection film onto the base substrate.

In still yet another aspect, the present disclosure provides in some embodiments a display panel including the above-mentioned display substrate with the light reflection film.

In still yet another aspect, the present disclosure provides in some embodiments a display device including the above-mentioned display panel and a backlight module. Light reflected by the light reflection film reaches the backlight module, is reflected by the backlight module and enters the display panel.

According to the embodiments of the present disclosure, the backlight that should have been absorbed by the black matrix may be utilized so as to increase a brightness value, improve a display effect and reduce the power consumption. In addition, it is able to prevent the backlight that should have been absorbed by the black matrix from being reflected within the display panel, thereby to improve the display effect.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a sectional view of a LCD in the related art;

FIG. 2 is a schematic view showing light transmittances of respective portions of the LCD in the related art;

FIG. 3 is a schematic view showing a display device including a display substrate according to at least one embodiment of the present disclosure;

FIG. 4 is another schematic view showing the display device including the display substrate according to at least one embodiment of the present disclosure;

FIG. 5 is yet another schematic view showing the display device including the display substrate according to at least one embodiment of the present disclosure;

FIG. 6 is still yet another schematic view showing the display device including the display substrate according to at least one embodiment of the present disclosure;

FIG. 7 is still yet another schematic view showing the display device including the display substrate according to at least one embodiment of the present disclosure;

FIG. 8 is still yet another schematic view showing the display device including the display substrate according to at least one embodiment of the present disclosure; and

FIG. 9 is still yet another schematic view showing the display device including the display substrate according to at least one embodiment of the present disclosure.

### REFERENCE SIGN LIST

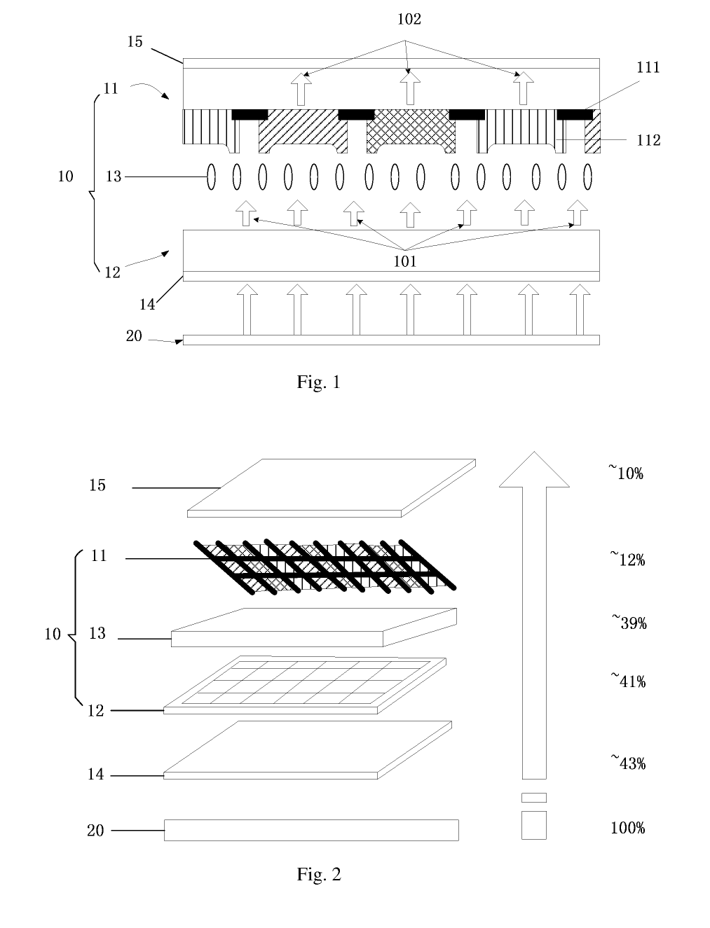

In FIGS. 1 and 2:

10 display panel

11 color filter substrate

12 array substrate

13 liquid crystal layer

14 lower polarizer

15 upper polarizer

111 black matrix

112 color filter film

20 backlight module

101 backlight absorbed by black matrix

102 backlight passing through display panel

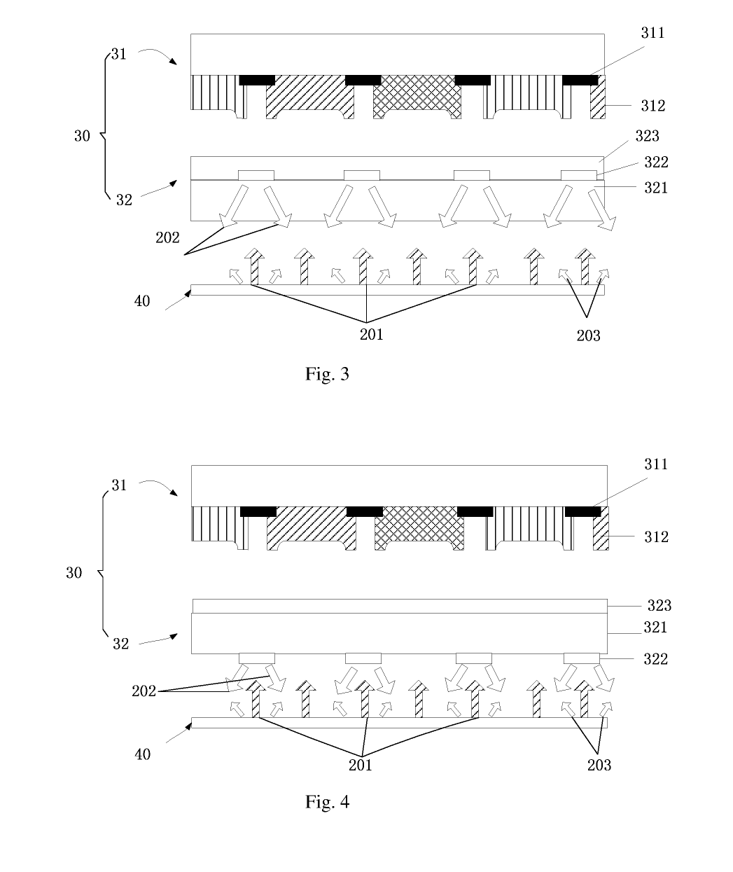

In FIGS. 3-9:

30 display panel

31 opposite substrate

32 display substrate

311 black matrix

312 color filter film

321 base substrate

322 photoluminescent device

323 TFT

324 light reflection film

3221 photoluminescent layer

3222 light-shielding layer

40 backlight module

201 first light beam emitted from backlight module toward black matrix region

202 second light beam emitted from photoluminescent device

203 third light beam reflected by backlight module

204 first reflected light beam reflected by light reflection film

205 second reflected light beam reflected by backlight module

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

Referring to FIG. 1 which is a sectional view of a LCD in the related art and FIG. 2 which is a schematic view showing light transmittances of respective portions of the LCD in the related art, the LCD includes a display panel 10, a lower polarizer 14 and an upper polarizer 15 arranged on the display panel 10, and a backlight module 20. The display panel 10 includes an array substrate 11, a color filter substrate 12 and a liquid crystal layer 13. The color filter substrate 12 includes a color filter film 112 and a black matrix (BM) 111, and the BM 111 functions as to shield a light beams, so as to achieve a better display effect. However, a part of backlight (e.g., a light beam 101 in FIG. 1) may be absorbed by the BM 111, so the backlight transmittance may be remarkably reduced and thereby the light efficiency may be adversely affected (in FIG. 1, 102 represents a light beam passing through the display panel 10). As shown in FIG. 2, a remarkable light loss may occur due to the absorption the BM 111. Hence, there is an urgent need to improve the backlight utilization.

Referring to FIG. 3, which is a schematic view showing a display device including a display substrate according to at least one embodiment of the present disclosure, the display substrate 32 may form a cell with an opposite substrate 31 on which a color filter film 312 and a BM 311 are arranged. The display substrate 32 includes a base substrate 321 and a photoluminescent device 322 arranged on the base substrate 321. The photoluminescent device 322 is arranged at a position corresponding to the BM 311 and located at a side of the BM 311 facing a backlight module 40. A projection of the photoluminescent device 322 onto the base substrate 321 at least partially overlaps a projection of the BM 311 onto the base substrate 321. The photoluminescent device 322 is configured to emit light under an excitation of a light beam.

As shown in FIG. 3, a first light beam 201 generated by the backlight module 40 toward a BM region may be absorbed by the photoluminescent device 322. Under the excitation of the first light beam 201, a second light beam 202 may be generated by the photoluminescent device 322, reach the backlight module 40, and be reflected by the backlight module 40. Then, a reflected third light beam 203 may enter the display substrate 32. The entire procedure may be repeated. In this way, it is able to increase a brightness value, improve a display effect and reduce the power consumption. In addition, it is able to prevent the backlight that should have been absorbed by the black matrix from being reflected within the display panel, thereby to improve the display effect.

In the embodiments of the present disclosure, the display substrate 32 is an array substrate, and the opposite substrate 31 is a color filter substrate.

In the embodiments of the present disclosure, the photoluminescent device 322 is arranged between the base substrate 321 and a TFT 323, so as to prevent the TFT from being adversely affected by the light beam generated by the photoluminescent device 322.

Alternatively, in some other embodiments of the present disclosure, the photoluminescent device 322 may also be arranged at another position, e.g., as shown in FIG. 4, the photoluminescent device 322 may be arranged at a surface of the base substrate 321 that is at a side of the base substrate 321 further away from the TFT 323 than the other side of the base substrate 321, i.e., at the surface at the side of the base substrate facing the backlight module 40.

In some embodiments of the present disclosure, in the case that a polarizer is arranged at a side of the base substrate 321 of the display substrate 32 facing the backlight module 40, the photoluminescent device 322 may also be arranged at a side of the polarizer facing the backlight module.

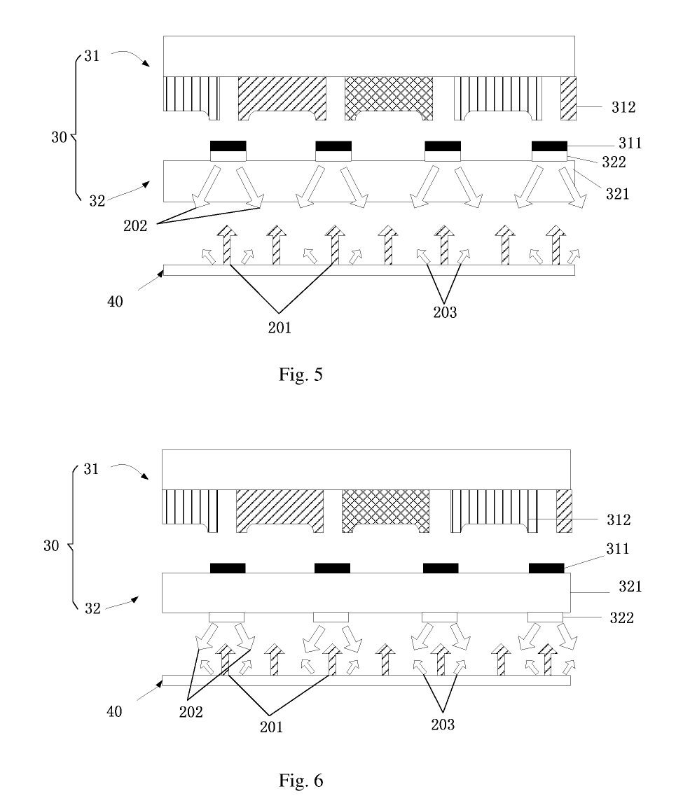

As shown in FIGS. 3 and 4, the BM 311 is arranged on the opposite substrate 31. In some other embodiments of the present disclosure, as shown in FIGS. 5 and 6, the BM 311 may also be arranged on the display substrate 32. In FIG. 5, the photoluminescent device 322 is arranged at a side of the base substrate 321 that is further away from the backlight module 40 than the other side of the base substrate 321, while in FIG. 6, the photoluminescent device 322 is arranged at a side of the base substrate 321 facing the backlight module 40.

As shown in FIGS. 3-6, the projection of the photoluminescent device 322 onto the base substrate 321 completely overlaps the projection of the BM 311 onto the base substrate 321, i.e., the photoluminescent device 322 may completely shield the BM 311, such that the photoluminescent device 322 may receive all the backlight transmitted toward the BM region, thereby to improve the light utilization. In addition, the photoluminescent device 322 may not shield the light beams toward a display region of the opposite substrate.

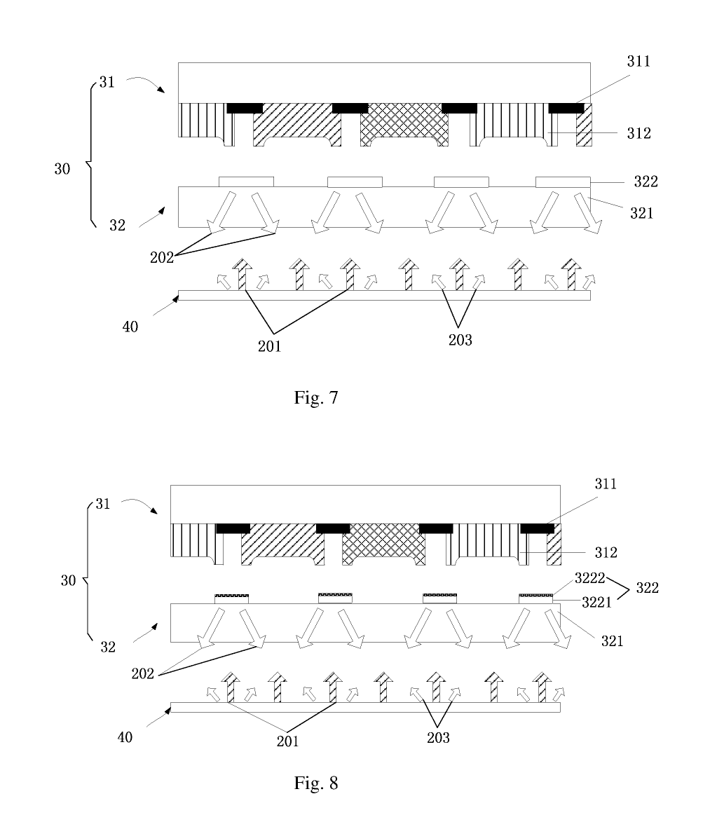

Alternatively, in some other embodiments of the present disclosure, as shown in FIG. 7, the projection of the photoluminescent device 322 onto the base substrate 321 may be of an area larger than an area of the projection of the BM 311 onto the base substrate 321, and the projection of the BM 311 onto the base substrate 321 is completely located within the projection of the photoluminescent device 322 onto the base substrate 321. In this way, it is able for the photoluminescent device to receive all the backlight transmitted toward the BM region.

In some other embodiments of the present disclosure, the projection of the photoluminescent device 322 onto the base substrate 321 may also be of an area smaller than an area of the projection of the BM 311 onto the base substrate 321, and the projection of the photoluminescent device 322 onto the base substrate 321 may partially overlap the projection of the BM 311 onto the base substrate 321. In this way, it is able for the photoluminescent device to receive a part of the backlight transmitted toward the BM region but not shield the light beams transmitted toward the display region of the opposite substrate.

In a possible embodiment of the present disclosure, the photoluminescent device 322 is a nonconductive light-emitting film. The light-emitting film may emit light upon the light-emitting film receives the backlight, without providing any electrode at either side of the light-emitting film or connecting the light-emitting film to any circuit, so the photoluminescent device is of a simple structure. In addition, through the light-emitting film, it enables the whole photoluminescent device to serve as a surface light source other than a point light source, so as to improve the light efficiency and the light intensity. Further, through the light-emitting film, it is able to provide a thin display substrate, thereby to provide a light and thin display device. Naturally, the structure of the photoluminescent device is not limited to the light-emitting film, and the photoluminescent device of any other structure may also be used.

In a possible embodiment of the present disclosure, the light beam generated by the photoluminescent device 322 may be transmitted in a direction away from the BM 311, rather than toward the BM 311. In other words, the light beam generated by the photoluminescent device 322 may be transmitted approximately in a direction toward the backlight module 40 (including directions vertically and not vertically toward the backlight module 40), so as to utilize the light beam generated by the photoluminescent device 322 to the greatest extent. For this purpose, in a possible embodiment of the present disclosure, as shown in FIG. 8, the photoluminescent device 322 may include a photoluminescent layer 3221 and a light-shielding layer 3222 arranged between the photoluminescent layer 3221 and the BM 311. Through the light-shielding layer 3222, the light beam generated by the photoluminescent layer 3221 may be transmitted in the direction away from the BM 311.

In a possible embodiment of the present disclosure, the light-shielding layer 3222 includes a light reflection surface, which is at a side of the light-shielding layer 3222 further away from the BM than at the other side of the light-shielding layer 3222, i.e., a surface of the light-shielding layer 3222 facing the photoluminescent layer 3221. In this way, it is able to reflect the light beam generated by the photoluminescent layer 3221 and emitted toward the BM 311 (i.e., reflect the light beam in the direction away from the BM 311), thereby to improve the light utilization.

In the embodiments of the present disclosure, the photoluminescent layer 3221 may be made of a matrix and a photoluminescent material doped in the matrix. The photoluminescent material may be a fluorescent powder, a quantum dot luminescent material or a phosphor material. The photoluminescent material may emit light after being irradiated with ultraviolet light, sun light or common lamplight, so it is considered as an excellent green light source. In addition, the photoluminescent material has excellent optical, thermal and chemical stability, and during the production and utilization thereof, it may not contain or generate any hazardous substances. The matrix may be made of a material such as resin.

The present disclosure further provides in some embodiments a display panel including the above-mentioned display substrate.

The present disclosure further provides in some embodiments a display device including the above-mentioned display panel and a backlight module. Light generated by the photoluminescent device is transmitted in a direction away from the BM toward the backlight module, is reflected by the backlight module, and then enters the display panel.

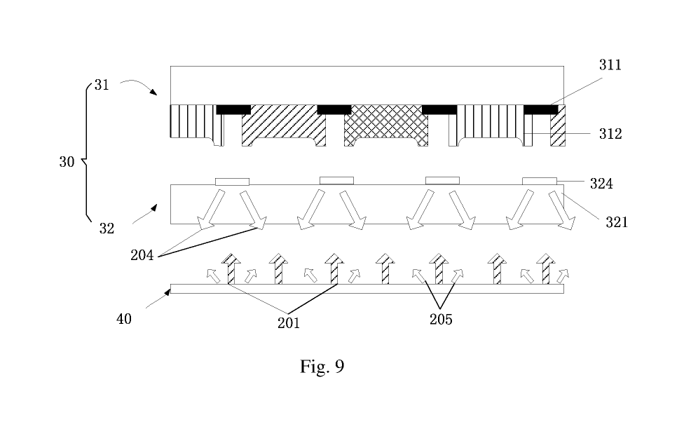

Referring to FIG. 9 which is a schematic view showing the display device including another display substrate, the display substrate 32 may form a cell with the opposite substrate 31 on which the BM is arranged. The display substrate 32 includes the base substrate 321 and a light reflection film 324 arranged on the base substrate 321. The light reflection film 324 is arranged at a position corresponding to the BM 311 and located at a side of the BM 311 facing the backlight module 40. A projection of the light reflection film 324 onto the base substrate 321 at least partially overlaps the projection of the BM 311 onto the base substrate 321. A light reflection surface of the light reflection film 324 is a at a side of the light reflection film 324 that is further away from the BM 311 than the other side of the light reflection film 324.

In the embodiments of the present disclosure, the display substrate 32 is an array substrate, and the opposite substrate 31 is a color filter substrate.

As shown in FIG. 9, the first light beam 201 generated by the backlight module 40 toward the BM region may reach the light reflection film 324. Upon the reception of the first light beam 201, a first reflected light beam 204 may be reflected by the light reflection film 324 toward the backlight module 40, and then reflected by the backlight module 40 to form a second reflected light beam 205. Then, the second reflected light beam 205 may enter the display substrate 32. This procedure may be repeated. In this way, it is able to increase a brightness value, improve a display effect and reduce the power consumption. In addition, it is able to prevent the light beam that should have been absorbed by the BM from being reflected within the display panel, thereby to further improve the display effect.

In a possible embodiment of the present disclosure, the projection of the light reflection film 324 onto the base substrate 321 completely overlaps the projection of the BM 311 onto the base substrate 321, i.e., the light reflection film 324 may completely shield the BM 311. In this way, it is able for the light reflection film 324 to receive and reflect all the backlight emitted toward the BM region, thereby to improve the light utilization. In addition, the light reflection film 324 may not shield the light beam emitted toward a display region of the opposite substrate.

In some other embodiments of the present disclosure, the projection of the light reflection film 324 onto the base substrate 321 may be of an area greater than the projection of the BM 311 onto the base substrate 321, and the projection of the BM 311 onto the base substrate 321 is completely located within the projection of the light reflection film 324 onto the base substrate 321. In this way, it is also able for the light reflection film 324 to receive and reflect all the backlight emitted toward the BM region.

In some other embodiments of the present disclosure, the projection of the light reflection film 324 onto the base substrate 321 may be of an area smaller than, and partially overlap, the projection of the BM 311 onto the base substrate 321. In this way, it is able for the light reflection film 324 to receive and reflect a part of the backlight emitted toward the BM region. In addition, the light reflection film 324 may not shield the light beam emitted toward the display region of the opposite substrate.

In a possible embodiment of the present disclosure, the light reflection film 324 may be arranged between the base substrate 321 and a TFT (not shown) on the display substrate 32, or at a side of the base substrate 321 that is further away from the TFT than the other side of the base substrate 321, so as to prevent the TFT from being adversely affected.

The present disclosure further provides in some embodiments a display panel including the above-mentioned display substrate with the light reflection film.

The present disclosure further provides in some embodiments a display device including the above-mentioned display panel and a backlight module. Light reflected by the light reflection film reaches the backlight module in a direction away from the BM, is reflected by the backlight module and enters the display panel.

The present disclosure further provides in some embodiments a method for manufacturing the above-mentioned display substrate.

In the case that the display substrate includes the photoluminescent device, the method may include: Step S1 of placing a mask plate above the base substrate, the mask plate being provided with a transparent region at a position and a nontransparent region, wherein the transparent region corresponds to a position of the BM and has a size consistent with a size of the BM; Step S2 of coating or plating a fluorescent powder glue onto the base substrate; Step S3 of removing the mask plate; and Step S4 of drying the fluorescent powder glue so as to form the photoluminescent device.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. A display substrate for forming a cell with an opposite substrate, wherein the display substrate comprises: a base substrate, and an optical device arranged on the base substrate and configured to emit light,
wherein the optical device is arranged at a position corresponding to a black matrix and located at a side of the black matrix facing a backlight module; and
a projection of the optical device onto the base substrate at least partially overlaps a projection of the black matrix onto the base substrate.

2. The display substrate according to claim 1, wherein the optical device is a photoluminescent device configured to emit light under an excitation of a light beam.

3. The display substrate according to claim 2, wherein the projection of the photoluminescent device onto the base substrate completely overlaps, or is located within, the projection of the black matrix onto the base substrate.

4. The display substrate according to claim 2, wherein the photoluminescent device comprises a photoluminescent layer and a light-shielding layer arranged between the photoluminescent layer and the black matrix.

5. The display substrate according to claim 4, wherein the light-shielding layer comprises a light reflection surface at a side of the light-shielding layer that is further away from the black matrix than the other side of the light-shielding layer.

6. The display substrate according to claim 4, wherein the photoluminescent layer is made of a matrix and a photoluminescent material doped within the matrix.

7. The display substrate according to claim 2, wherein the photoluminescent device is arranged between the base substrate and a thin film transistor (TFT) on the display substrate, or arranged at a surface at a side of the base substrate that is further away from the TFT than the other side of the base substrate.

8. The display substrate according to claim 2, wherein a polarizer is arranged at a side of the base substrate facing the backlight module, and the photoluminescent device is arranged at a side of the polarizer facing the backlight module.

9. The display substrate according to claim 2, wherein the black matrix is arranged on the display substrate or the opposite substrate.

10. The display substrate according to claim 2, wherein the projection of the black matrix onto the base substrate is located within the projection of the photoluminescent device onto the base substrate.

11. The display substrate according to claim 2, wherein the photoluminescent device is a nonconductive light-emitting layer.

12. The display substrate according to claim 2, wherein the light generated by the photoluminescent device is transmitted in a direction away from the black matrix.

13. The display substrate according to claim 1, wherein the optical device is a light reflection film, and a light reflection surface of the light reflection film is at a side of the light reflection film that is further away from the black matrix than the other side of the light reflection film.

14. The display substrate according to claim 13, wherein the projection of the light reflection film onto the base substrate completely overlaps, or is located within, the projection of the black matrix onto the base substrate.

15. The display substrate according to claim 13, wherein the light reflection film is arranged between the base substrate and a TFT on the display substrate, or at a side of the base substrate that is further away from the TFT than the other side of the base substrate.

16. (canceled)

17. The display substrate according to claim 13, wherein the projection of the black matrix onto the base substrate is located within the projection of the light reflection film onto the base substrate.

18. A display panel including the display substrate according to claim 1.

19. A display device including the display panel according to claim 18 and a backlight module, wherein light generated by the photoluminescent device reaches the backlight module, is reflected by the backlight module and enters the display panel.

20. A display panel including the display substrate according to claim 13.

21. A display device including the display panel according to claim 20 and the backlight module, wherein light reflected by the light reflection film reaches the backlight module, is reflected by the backlight module and enters the display panel.
